(19) United States
(12) Patent Application Publication
(10) Pub. No.: US 2006/0001998 A1
(43) Pub. Date: Jan. 5, 2006

(54) Automatically initiated recording-and-playing device digital recorder

(76) Inventor: Wan Feng Terry Teng, San Jose, CA (US)

Correspondence Address: TROXELL LAW OFFICE PLLC, SUITE 1404, 5205 LEESBURG PIKE, FALLS CHURCH, VA, 22041, US

(21) Appl. No.: 10/879,000

(22) Filed: Jun. 30, 2004

(51) Int. Cl. G11B 19/02

(52) U.S. Cl. 360/69

(57) ABSTRACT

An automatically initiated recording-and-playing device for a digital recorder, the device has a passive infrared sensing device integrally connected with a digital recorder by means of a switch, so that the passive infrared sensing device forms at least one of an automatically recording mode and an automatically playback mode after sensing and detecting for the digital recorder. The device can automatically complete transmission of recording and playing messages without manipulation of a person.

### BACKGROUND OF THE INVENTION

1. Field of the Invention

The present invention is related to an automatically initiated recording-and-playing device for a digital recorder, and especially to such a device using a passive infrared sensing device to automatically initiate for recording and playing, it can be applied on devices such as a toy, a household memo device and a theft-proof device without manipulation of a person.

2. Description of the Prior Art

Following fast advancing of the modern technique of the voice IC, recorders have been gradually miniaturized from a conventional fixed structural style with large volumes. Such miniaturization of recording devices not only has the advantage of not occupying large volumes, but also renders the devices suitable for use in the mode of carrying on ones' persons.

However, no matter a recorder is a conventional large one or a pocket digital recording device (such as a recording pen for carrying on use's person), basically it needs a user to operate for recording and playing. For example, the user must press a predetermined recording key (“REC”) in recording, and must press a predetermined playing key (“PLAY”) in playing. That is, such recording devices available presently still rely on users to do recording and playing manually. Moreover, the voice ICs used in miniaturized recording devices available presently are less ideal both in quality and volume of sound.

The techniques for modern infrared sensing devices also have been elevated, an example among them is to apply passive infrared (PIR) devices on various automatic lighting devices or home security systems, such as on an indoor automatic lighting device or a monitor. The passive infrared (PIR) devices are used mainly to sense infrared photosensitive elements, they use surrounding temperature differences and displacements between the thermostatic articles and backgrounds to judge and initiate. Basically, when passive infrared (PIR) detects a temperature difference and a displacement, it will initiate a relay or a transistor to control an electric power for a load (such as an illuminating lamp).

### SUMMARY OF THE INVENTION

The primary object of the present invention is to provide an automatically initiated recording-and-playing device for a digital recorder that can automatically complete transmission of recording and playing messages without manipulation of a person.

Another object of the present invention is to provide an automatically initiated recording-and-playing device for a digital recorder that can drive and manipulate with an extremely low voltage.

Another object of the present invention is to provide an automatically initiated recording-and-playing device for a digital recorder that can be accommodated and positioned in a housing of a small volume to be applied conveniently on one of various products.

To achieve the above stated object, the present invention has a passive infrared sensing device integrally connected with a digital recorder by means of a switch, so that the passive infrared sensing device forms at least one of an automatically recording mode and an automatically play back mode after sensing and detecting for the digital recorder.

In a practicable embodiment, the above stated passive infrared sensing device is a pyroelectric passive infrared sensor.

In a preferred embodiment, the above stated recording device is connected externally with an amplifier and a microphone.

The present invention will be apparent in its novelty and other features after reading the detailed description of the preferred embodiment thereof in reference to the accompanying drawings.

### BRIEF DESCRIPTION OF THE DRAWINGS

FIG. 1 is a diagram showing a preferred embodiment of the present invention.

### DETAILED DESCRIPTION OF THE PREFERRED EMBODIMENT

The embodiment given and shown in the drawing is for the purpose of illustrating the present invention rather than for limiting the scope of the present invention; the technique disclosed hereinafter is subjected to changing and modification by one skilled in this art.

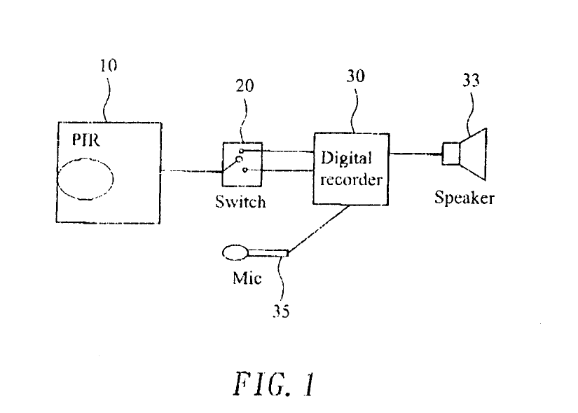

Referring to FIG. 1, in the preferred embodiment depicted, the present invention has a passive infrared (PIR) sensing device 10 integrally connected with a digital recorder 30 by means of a switch 20, so that the passive infrared (PIR) sensing device 10 forms at least one of an automatically recording mode and an automatically play back mode after sensing and detecting for the digital recorder 30.

In an ideal embodiment, the above stated passive infrared (PIR) sensing device 10 is a pyroelectric passive infrared sensor.

In the preferred embodiment shown, the digital recorder 30 of the present invention is connected externally with an amplifier 33 and a microphone 35 to elevate quality and volume of sound of the whole device.

By the fact that the techniques of passive infrared (PIR) and digital recorders have been largely elevated, the above stated embodiment of the present invention can be driven and manipulated with an extremely low voltage. For example, the voltage for operation of the present invention needs only to be about 3 volts, i.e., two No. 2 batteries (AA) sold in the market can afford the operation conveniently.

A more desired advantage is that, the above stated embodiment of the present invention can be accommodated and positioned in a housing of a small volume (not shown) to be applied conveniently on one of various products. For example, the present invention can be applied on devices such as a toy, a household memo device and a theft-proof device.

In the case that the present invention is used on an indoor (of home or office) memo device, the one leaving a message can make connection of the device, the latter can immediately automatically initiate to get the recording mode; when in completion of recording, and the one concerned (to be left with the message) get close to the deivce, the latter can immediately automatically initiate to get the play back mode; and the content of the message can be automatically played to let know of the one concerned. During the entire transmitting process of the message, the one giving and the one receiving the message completely need no action of manipulation for turning on/off or pressing a key.

The embodiment given is only for illustrating the present invention, and not for giving any limitation to the scope of the present invention. It will be apparent to those skilled in this art that various modifications or changes without departing from the spirit of this invention shall also fall within the scope of the appended claims.

1. An automatically initiated recording-and-playing device for a digital recorder, said device has a passive infrared device integrally connected with said digital recorder by means of a switch, so that said passive infrared sensing device forms at least one of an automatically recording mode and an automatically play back mode after sensing and detecting for said digital recorder.

2. The automatically initiated recording-and-playing device for a digital recorder as in claim 1, wherein:
said passive infrared sensing device is a pyroelectric passive infrared sensor.

3. The automatically initiated recording-and-playing device for a digital recorder as in claim 1, wherein:
said digital recorder is connected externally with an amplifier and a microphone.
